(19) United States
(12) Patent Application Publication
(10) Pub. No.: US 2009/0254970 A1
(43) Pub. Date: Oct. 8, 2009

(54) MULTI-TIER SECURITY EVENT CORRELATION AND MITIGATION

(75) Inventors: Amit Agarwal, Milpitas, CA (US); David Ahrens, San Jose, CA (US); Rod Livingood, Cupertino, CA (US); Mahalingam Mani, Cupertino, CA (US); Navjot Singh, Denville, NJ (US); Andrew Zmolek, Highlands Ranch, CO (US)

Correspondence Address: SHERIDAN ROSS P.C., 1560 BROADWAY, SUITE 1200, DENVER, CO, 80202, US

(73) Assignee: AVAYA INC., Basking Ridge, NJ (US)

(21) Appl. No.: 12/234,248

(22) Filed: Sep. 19, 2008

Related U.S. Application Data
(60) Provisional application No. 61/042,458, filed on Apr. 4, 2008.

(51) Int. Cl. G06F 21/00

(52) U.S. Cl. 726/1

(57) ABSTRACT

The present invention is directed to the use of a multi-tiered security architecture that includes vendor-operated global security services and policy servers able to exchange security events and mitigation measures.

### CROSS REFERENCE TO RELATED APPLICATION

The present application claims the benefits of U.S. Provisional Application Ser. No. 61/042,458, filed Apr. 4, 2008, of the same title, which is incorporated herein by this reference in its entirety.

### FIELD

The invention relates generally to communication security systems and methodologies and particularly to attack detection and/or protection systems and methodologies.

### BACKGROUND

In the information-centric world of today, computer networks are dominant. Protection of these networks from attackers is an ongoing, dynamically changing task. Not only must a computer network be secured from innumerable, unknown electronic invaders but also effective security systems must accommodate the inherent complexity of computer systems. Each computer and other network device has unexpected vulnerabilities and failure modes. Connecting computers and devices together into complex systems increases the potential problems combinatorially.

Effective security systems must address three stages, namely prevention (to avoid attacks, if possible), detection (to know as soon as possible when an attack attempt occurs), and reaction (to respond to an attack and prevent and detect it in the future). To address these three stages, Intrusion Detection Systems (IDS') detect attack attempts as they occur, while protection systems take appropriate actions in response to detected attack attempts.

IDS' normally fall into a number classifications. These classifications include network-based, host-based, protocol-based, and application-based intrusion detection systems. Combinations of these classifications are common. These combinations, also known as hybrid intrusion detection systems, including, for example, a combination of network-based and host-based intrusion detection systems. A key vehicle for IDS' and protection systems is event correlation. Event correlation is the automated, continuous analysis of enterprise-wide normalized and real time security event data based on user-defined, configurable rules. The rules identify critical threats and complex attack patterns, thereby facilitating the prioritization of events and the initiation of effective incident response(s). Event correlation receives events, which are auditable occurrences on a network or the smallest elements of IDS data, from multiple, disparate sources. Agents in those sources conduct binary pass/fail event evaluations based on true or false conditions to identify events needing analysis by the event correlation engine. The events are filtered by the engine to remove unwanted information, thereby reducing analytical errors or misrepresentations. Using correlation rules, the filtered events are correlated by the engine and abnormal patterns detected. Appropriate responses may then be implemented to prevent or stop attacks.

Security event correlation systems today typically rely on a single, monolithic domain for event correlation with agents that make binary decisions. A single-domain approach can be inefficient and not scalable. Components in single-domain systems are also not independently survivable. The agents in the various event sources are unable to make independent decisions without connectivity to a central event correlation engine.

### SUMMARY

These and other needs are addressed by the various embodiments and configurations herein. These embodiments and configurations relate to multi-tiered security systems, one or more tiers of which is/are further divided into correlation domains.

In one embodiment, an enterprise network includes:

(a) a number of security agents, each in communication with a respective protection device, each protection device performing a security function and the security agents and respective protection device being arranged in a number of domains; and

(b) a number of policy servers, each policy server controlling the security agents in a respective domain.

In one configuration, each policy server correlates a set of events against a policy and, when directed by the policy, provides a description of the set of events to a global service being involved in an attack type associated with the set of events. The global service is operated by a vendor distinct from an enterprise operating the enterprise network and may specialize in countering and mitigating one or more specific types of attack.

In another configuration, each policy server correlates a set of events against a policy and derives a rule and, when directed by the policy, provides the derived rule to a different policy server in a different domain. The rule is discretionary to the different policy server. In contrast, the rule is mandatory to the agents controlled by the policy server which derived the rule.

The policy includes one or more scoping tags, which indicate a scope of applicability of the policy. For example, a scoping tag identifies an object, such as a communication medium, a protocol, a global service, a policy server, an agent, a class of agents, and the like. It generally does not identify a type of attack.

In one implementation, a Self-Protecting Communications (“SPC”) infrastructure is provided that enables local protection tier event processing by agents to proceed independently from event processing at domain and global orchestration tiers. Components at each of these three tiers can share intelligence to the tiers immediately above or below and, for the domain orchestration tier, to its peers within its own tier. In contrast, conventional security systems do not permit the proactive sharing of mitigation actions across multiple tiers for reinterpretation by heterogeneous mitigation systems. Conventional systems rely on signature or other policy database updates that retain an identical semantic construct across all hierarchical tiers. The distributed adaptive correlation mechanism afforded by the SPC infrastructure leverages the multiple tiers operating in parallel to substantially optimize event processing and provide a comprehensive view into the state of the systems at each of the tiers. Correlation engines at each tier operate independently but send summary information upwards as input into the next level for subsequent processing. Higher-level tiers can send optimization requests (e.g., correlation heuristics or rules) downwards for future correlation processing.

The various embodiments and configurations can provide a number of advantages depending on the particular configuration. By way of example, they can offer survivability with local event correlation. In the case of failure of or loss of communication with a higher tier, the local protection components can still perform local event correlation and mitigate threats based on locally stored policies, though they cannot send the events to the SPC server or receive new updates from the SPC server until the communication is re-established. Events will be stored and forwarded once communication is established. They can share intelligence across multiple correlation tiers in addition to the ability to do so through policy database updates. They can protect communications infrastructures more completely than border-based security alone. The use of tiers can provide for scalability.

These and other advantages will be apparent from the disclosure of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram depicting an embodiment;

FIG. 2 is a block diagram depicting an embodiment;

FIG. 3 is a flow chart according to an embodiment;

FIG. 4 is a flow chart according to an embodiment;

FIG. 5 is a flow chart according to an embodiment; and

FIG. 6 is a flow chart according to an embodiment.

### DETAILED DESCRIPTION

### Overview of the Architecture

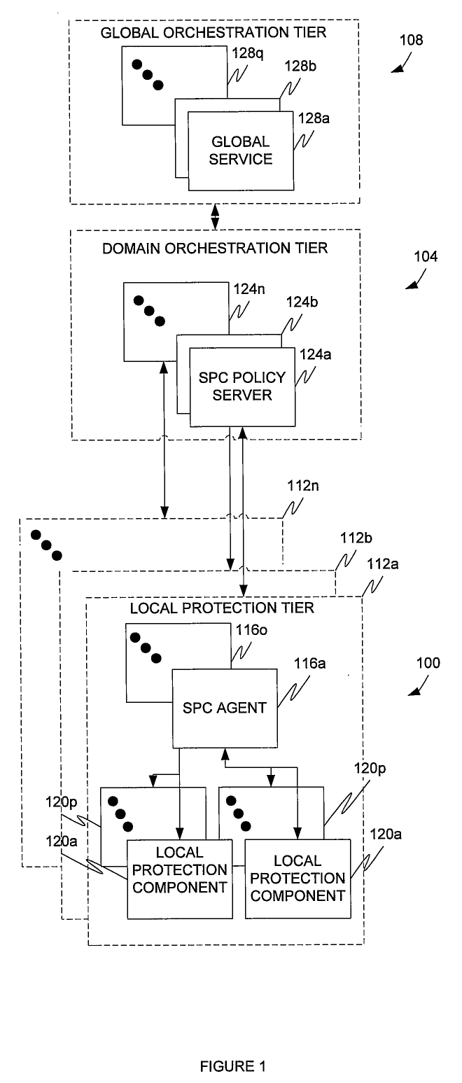

With reference to FIG. 1, a multi-tier network security system is illustrated. The system includes three tiers, namely a local protection tier 100, a domain orchestration tier 104, and a global orchestration tier 108. Domain event summaries from the local protection tier 100 are pushed to or pulled by the domain orchestration tier 104, and global event summaries from the orchestration tier 104 are pushed to or pulled by the global orchestration tier 108. Event processing in each tier proceeds independently of the other tiers, though components in each of the three tiers can share intelligence to the tiers immediately above or below the host tier.

The local protection tier 100 includes a plurality of defined domains 112a-n, each including one or more SPC agents 116a-o. Each agent is in communication with one or more local protection components 120a-p. Each domain 112a-n is a connected cluster of communicating entities (e.g., SPC agents and/or their respective host local protection components and those components not containing SPC agents), referred to as members of the domain, that are protected by a common set of communication security policies applied by Self-Protecting Communication (“SPC”) agents 116a-o positioned along the logical or physical boundary of the respective domain or within the domain (e.g., the SPC agent host local protection component is not the first component in the domain receiving a communication but subsequently receives the communication directly or indirectly from a local protection component at the domain boundary). SPC agents monitor the local protection components and enforce the defined security policy, which defines the boundary of usage and enforcement. SPC agents, within a selected domain, are normally classified by the security measure(s), operation(s), or service(s) for which they are responsible.

A domain can be as small as one host or as large as several networks. Typically, domains are logically and/or physically non-overlapping. A member of a first domain is not a member of a different second domain.

The local protection components can be any device or computational module, such as security gateways, firewalls, file integrity checkers, file access control lists, application white/black lists, and the like, with security gateways and firewalls being more typical. Local protection component(s) are typically slaved to an SPC agent, and are positioned logically in-line with, network traffic. With respect to event processing, the SPC agent normally works asynchronously to the operation of the local protection component slaved to it.

The SPC agents may be disparate from or resident in a local protection component(s). Rule-set language for the slaved local protection component is native to the component, and, other than its controlling SPC agent, the component is not aware of the SPC architecture.

The domain orchestration tier 104 includes SPC (policy) servers 124a-n. One SPC server 124 corresponds to one, and typically only one, domain 112. Unlike SPC agents, which receive events typically from only one host device, SPC servers typically substantially simultaneously receive events and/or event summaries from multiple members of the respective domain.

The global orchestration tier 108 contains a plurality of global services 128a-q. Each global service normally has a narrowly defined area of interest but serves multiple domains. For example, a global service may address only nuisance communications including Spam over Internet Telephony (“SPIT”). Other examples of areas of interest include attack signature update service, DDoS, anti-virus, and any other security-oriented service able to correlate input from large numbers of sources at a large scale and suggest new rules to combat the threats it detects. Typically, global services are operated by vendors offering a subscription service to the enterprise. For example, the SPIT global service could be a global anti-SPIT service that tracks real time SPIT outbreaks around the globe.

### SPC Agent and Server

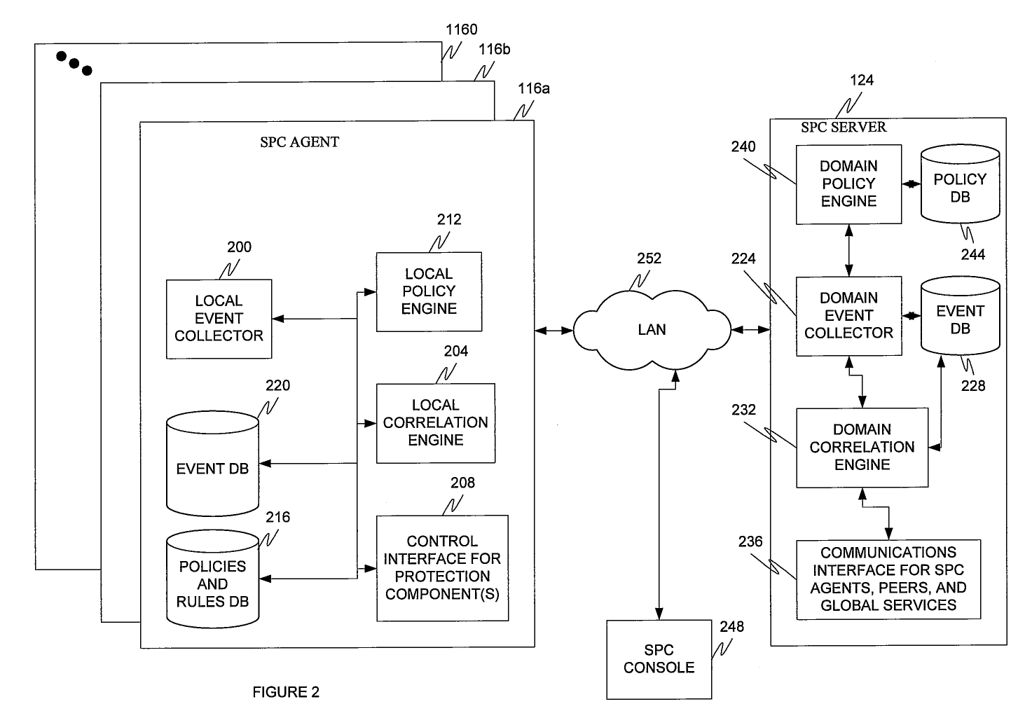

The SPC agent 116 and server 124 will be further discussed with reference to FIG. 2.

Prior to discussing these components, however, it is important to understand security policies and correlation rules.

A security policy, or policy directive, is a user configurable set of one or more defined rules that specify security services, operations, and/or measures, such as restriction of access, required to protect specified network traffic in or out of a security domain under specific conditions. Normally, a policy is a command interface between a system administrator and a network device, such that the administrator can instruct the device to perform specified security operations, and policies are normally uniform throughout a domain but may differ from domain-to-domain. An exemplary policy specifies thresholds for acceptable use and optionally an appropriate response when the thresholds are violated. Examples of policies include firewall policies and updates to firewall policies, intrusion detection signatures, and Universal Resource Locator (“URL”) filters. Policies may specify not only the security services but also requirements for administration of an SPC agent (e.g., who is permitted to apply/modify/delete rules belonging to an SPC agent).

A correlation rule is heuristically derived from the application of security policies to events encountered locally by SPC agents. A correlation rule is therefore a specific instance, or a subset, of a policy directive. An example of a correlation rule is a heuristically derived firewall rule or rule set. To further illustrate the difference between a policy (directive) and rule, a policy directive might be of the form “block any source IP address sending 100,000 or more INVITEs in a moving 10-second window, while the correlation rule generated from that policy to apply to a specific attack violating the policy might be “source IP address X is an offender, create a blocking rule.”

Policies and correlation rules can be applied to provide security for any layer, particularly security for network, transport and application layer(s).

Typically, policies and correlation rules are configured to detect critical threats and complex attack patterns facilitating the prioritization of events and the effective incident response. Normally, there are four policy and correlation rule types for effecting detection. Watch list policies and rules alert a user when events from any source contain a certain string pattern, such as deactivated user names, particular systems, IP address ranges, and the like. Basic correlation policies and rules allow a user to capture easily complex conditions across multiple real time events, such as a certain number of attacks to a particular system in a given time frame. Advanced policies and rules provide an additional layer of conditions on which to correlate both real time and recent events. Advanced policies and rules go beyond simply counting occurrences of a particular event to provide SPC agents with the ability to evaluate complex events, such as comparing events occurring outside a firewall to those occurring inside or triggering alerts based on events inside and outside a firewall or finding events that are not similar but should be. For example, an advanced policy or rule might analyze events from a basic correlation rule to discover that the targeted component is now the source for other potential Denial of Service (DoS) attacks, which may indicate that the targeted component has become a “zombie” for conducting Distributed Denial of Service (DDoS) attacks. Free form policies and rules provide a method to refine, further, rules or events to create new and highly complex situations that require multiple layers of logic. Creating a rule that depends on a certain sequence of complex attack patterns is an illustrative use of this rule type. Reactive and proactive mitigation policies and rules are addressed to attack prevention (e.g., rate limiting to 2 INVITEs/minute) or avoidance (e.g., when an attack signature is detected by a detection rule, drop matching INVITE for 20 minutes). Auditing policies and rules report data to SPC components. In one configuration, reports include typically source IP, Session Initiation Protocol (“SIP”) route information, and SIP Universal Resource Identifier (“URI”). Exception policies and rules provide exceptions to policies and rules (e.g., allow this URI to send more than 10 INVITEs/minute).

Where a communication among two or more network entities spans multiple domains, the security services or measures implemented to protect the communication can be combined.

In one configuration, all communications between members of the domain and other trusted (private) or untrusted (public) networks are processed by the SPC agents according to security policies of the domain while correlation rules are applied locally by SPC agent members of the domain. Thus while policies are uniformly applied domain-wide, different correlation rules may be applied by different SPC agents within a common domain. No communication path typically exists between members of a domain and another network that can bypass the protection of the SPC agents.

In one configuration, policies and rules have a common format. The format includes a description of an event type or set of event types, a set of thresholds (e.g., maximum number of user sessions allowed, application timeouts, time-of-day restrictions, restrictions based on local or access method, etc.), a time period over which the thresholds are enforced, a response when the event instances are applied to the previously discussed fields, a set of scope indicators, and a set of tags. The event type, for example, can describe packet or session type and/or selected field values characteristic of a corresponding attack signature. The event type or set of event types, set of thresholds, and time period collectively define an event pattern, such as an attack detection signature, characteristic of a specified attack type. The response can be any suitable response, such as generation of an alarm or notification to an administrator or user, initiation/generation of a remedial action, command, or native ruleset to counter, prevent, or mitigate an attack (e.g., direct a firewall to filter out the IP address of the attacker, forge TCP FIN packets to force the connections to terminate, or route packets to /dev/null), preparation of a detailed event log (e.g., save the attack information, such as timestamp, attacker IP address, victim IP address/port, and protocol information, and saving a trace file of the raw packets for later analysis), preparation and transmission of an event summary to a higher tier component, update of an existing policy, generation of a new policy, update of an existing correlation rule, generation of a new correlation rule, The scope indicators indicate the applicability of a given policy or rule to a given object, such as a global service 128a-q, SPC agent 116a-o, SPC agent class, media type, protocol or protocol defined entity, affected application, network, and/or subnet. A scope indicator, for example, is a value uniquely identifying a global service, an SPC agent, or class of SPC agents. By way of illustration, the scope indicator can be used to identify destinations for alarms, event summaries, new policy directives, updates to policy directives, new correlation rules, and updates to correlation rules and, in the case of SPC agents, designate which SPC agents have responsibility for applying the policies and rules. All policy directives contain one or more scope indicators. The tags indicate the type of attack associated with the corresponding attack signature. A tag, for example, is a value uniquely identifying an attack type. When a policy or rule triggers a response, the notifications, events, or event summaries generated or transmitted as part of the response may include some or all of the scoping indicators or tags in the policy or rule. Although the policy or rule can include one or more tags, the decision on where to propagate an event summary based on the policy or rule is normally independent of the attack type, or tag value. That is, the decision depends on the attack type only to the extent that the policy or rule defines an attack signature associated with a specific attack type.

There is a broad variety of attack types that can be detected and mitigated by the SPC architecture. In one configuration, the attack types include the following: device directed attacks, such as Denial of Service (“DoS”), Distributed Denial of Service (“DDoS”) (e.g., invite/options/registration flood), fuzzing (e.g., malformed packets), session anomalies, and forced call teardown (e.g., bye/cancel); topology directed attacks, such as DoS/DDo S/fuzzing, social attacks (e.g.,stealth/ Spam over Internet Telephony_ (“SPIT”)/phishing), and enumeration attacks (e.g., call walking/register/invite/option enumeration); Man-In-The-Middle (“MITM”) attacks such as eavesdropping, registration hijacking/session hijacking/redirection, session teardown, and proxy impersonation); media directed attacks, such as DoS attacks on media gateways, DoS attacks on communication systems, Dual Tone Multi Frequency (“DTMF”) attacks on voicemail, Interactive Response Units (“IRU's”) (such as an Interactive Voice Response Unit or IVR) or contact centers go gain unauthorized access, Real Time Protocol (“RTP”) payload hijacking, RTP tampering, and Session Description Protocol (“SDP”) redirect; and theft of service attacks, such as toll fraud, theft of intellectual property/confidential information (e.g., stealing other's voicemail). In another configuration, the SPC architecture detects and mitigates against malicious input attacks, brute force login detection attacks, buffer overflow attacks, flooding attacks, resource starvation or exhaustion attacks, malicious output attacks, automation detection attacks, and known vulnerability attacks.

Policies may be mandated by suitable authorities, such as network administration and users of communication applications. Rules and policies can be established for multiple protocol or OSI layers, including data link, network transport, and application layers. Unlike correlation rules which are mandatory, security policies can be either mandatory or discretionary. More specifically, policies are mandatory to SPC agents in all cases; mandatory to SPC servers when received from, configured or edited by, or created by administration; and discretionary to SPC servers in all other cases.

Policies and rules can stipulate trust scoring regarding the degree of trustworthiness of a selected source address, confidence scoring regarding whether a match is correct or a false positive, and other scoring or weighting mechanisms. As will be appreciated, confidence scoring can be indexed against sets of responses (which may differ in membership, urgency, and corrective measure severity). For example, a first lower confidence score may require simply an alarm to an administrator about a possible attack while a second higher confidence score may require not only the alarm but also a blocking rule to be forwarded to a local protection component.

The SPC agent 116 and SPC server 124 will now be discussed with reference to FIG. 2.

The SPC agent 116 includes a number of modules. It is normally resident in a local protection component and does not interfere with the native function of the component. Rather, it monitors the data processed by the component and, when appropriate, provides appropriate mitigation commands to the component.

A local event collector 200 in the SPC agent 116 receives specific events from one or more local protection components 120 (e.g., application validating/filtering engine, application, network firewall engine, security gateways, routers, switches, network attack detectors, system integrity verifiers, log file monitors, deception devices, and the like), acquires additional information, if needed, from the reporting local protection component, and filters the event information to form filtered events. Events are auditable occurrences on a network or the smallest elements of SPC agent data. Examples of events include a voice call failure, a successful voice call set up, failed login, authorization failures, rate limiting ON/OFF, protocol violations (e.g., malformed packets and failed MAC verifications), system integrity check failures (e.g., invalid, unsigned JAR/EAR/WAR files or binaries), and _degradation of quality of service of voice conversation. The collector 200 filters out unwanted or irrelevant information associated with an event. For example, processing rules filter the arriving log, event, and alert data, deciding what to keep and what to eliminate. What data is kept and for how long depends on the security policies of the enterprise.

A local correlation engine 204 receives, from the local event collector 200 and in substantial real time, filtered events and analyzes and correlates events based on security policies and correlation rules. In one configuration, the engine 204 performs behavior anomaly detection, such as by IDS signature or attack pattern correlation, location-based correlation, directional correlation, nested correlation, sequential correlation, compound correlation, and time-agnostic correlation methods, and initiates an automated response.

The control interface for protection component(s) 208 initiates the response required by the applicable policy or correlation rule applied by the local correlation engine 204. By way of illustration, the interface 208 sends mitigation commands to an application validation/filtering engine and local network firewall. In another illustration, the interface 208 creates a mitigation rule and forwards it to a local protection component. In another illustration, the interface 208 creates a new or updates an old correlation rule in accordance with the pertinent security policy.

The collective operation of the local correlation engine 204 and control interface 208 is illustrated by a number of examples. In one example, an alert is triggered if more than 25 events are destined to any single IP address within a moving 30-second window. In another example, when the events match a local Session Initiation Protocol (“SIP”) flood policy (e.g., receive 20 or more SIP INVITE packets in 30 seconds), the engine 204 passes the event to the control interface for protection component(s) (discussed below) to apply mitigation techniques, such as a rule blocking the source IP address.

The local policy engine 212 maintains the policies in the policies and rules database 216 (discussed below), distributes specific policies to other local SPC components, namely the local correlation engine 204 and control interface 208, and to local protection component(s), and receives new policies or policy updates from administration. In some configurations, the local policy engine 212 may arbitrate between domain policies and local policies and rules. Arbitration decisions may be made using techniques, such as source prioritization with scope filtering and least restrictive and most restrictive composition rules.

The local policies and rules database 216 contains both policies and correlation rules to be administered by the respective domain. Polices and rules are pushed to or pulled by the local policy engine 212, local correlation engine 204, and control interface 208.

The local event database 220 contains events, detailed reporting logs, trace files, and the like, corresponding to events received or collected by the SPC agent 116. Typically, the contents of the event database are restricted only to local events occurring in the respective domain of the SPC agent 116.

The SPC server 124 includes similar components to the SPC agent 116. The primary difference is that the SPC server processes and responds to event summaries received from multiple SPC agents while each SPC agent processes and responds to events received only from the local protection component(s) for which it is responsible. The SPC servers are also able to share intelligence and other information respecting attacks with its peers in the domain orchestration tier 104 and with global services 128 in the global orchestration tier 108.

The domain event collector 224 receives, from corresponding SPC agents in the domain of the server, event summaries. Event summaries typically include information regarding numerous events, which collectively satisfy an attack description defined in one or more policies or rules. Event summaries generally include source address associated with the attacker or victim, destination address(es) associated with the attacker or victim, description of the event types involved, event timestamps, a description of the response taken, and an identifier of the specific policy or correlation rule causing event summary preparation. The collector 224 saves the event summaries in the domain event database 228 (discussed below) and forwards the event summaries to the domain correlation engine 232. The domain event collector filters out event summaries from non-registered SPC agents. As will be appreciated, SPC agents are assigned to and register with a specific SPC server responsible for the domain containing the SPC agent.

The domain correlation engine 232, using domain policies and rules that are the same, similar, derived from, and/or different from local policies and correlation rules, correlates event summaries received from the various SPC agents 116 in the domain corresponding to the SPC server 124. By way of example, the domain correlation engine would apply a policy or rule requiring a local INVITE flood in multiple domains within a specified time period and received from a common IP address to be reported to the communications interface 236.

The communications interface 236 for SPC agents, peers, and global services initiates the response required by the applicable domain policy or correlation rule applied by the domain correlation engine 232. By way of illustration, the interface 236 sends one or more of mitigation commands, alarms, attack notifications, new policies, policy updates, new rules, and rule updates to SPC agents at the local protection tier in the corresponding domain of the SPC server 124, domain orchestration tier peers of the SPC server 124, and global services 128 in the global orchestration tier 108. Typically, the SPC server 124 sends only a domain event summary to the selected global service(s). The domain event summary references and describes, or contains selected information from, at least a selected number of local correlation event summaries.

Global services receive only information stipulated by the applicable policy or rule (which contains a scoping indicator identifying the specific global service and/or type of information to be provided to the service). For example, a global SPIT service would receive only summaries of nuisance calls and not virus reports or DoS reports. No policies or rules are generally sent by the server to a global service. Receipt by an SPC server of duplicated local or domain event summaries from peers in the domain orchestration level is possible. Duplicated local or domain event summaries include a correlation vector, which can provide useful information. Normally, event summaries received from an SPC server peer are weighted differently and processed based on source; that is, SPC servers will typically have different weights applied by a receiving peer to event summaries sourced by the servers. SPC servers identify global services by any suitable technique, including UDDI, DHCP, SLP, or static configuration discovery techniques.

The collective operation of the domain correlation engine 232 and communication interface 236 is illustrated by a number of examples. In one example, an alert is triggered if more than 2 event summary reports indicate an instance of a possible SIP INVITE flood attack by a single IP source address within a moving 1 minute window. In other examples, the response to the flood is to provide a notification to SPC agents of the appropriate class throughout the SPC server's domain to block the source IP address. The SPC server can also send a notification of the anomalous behavior to its peers and prepare and send a domain event summary to a global service of the type that handles SIP INVITE flood attacks.

The domain policy engine 240 maintains the domain policies in the policy database 244 (discussed below), distributes specific policies to other SPC components, namely, at the local protection tier, to SPC agents providing event summaries to the SPC server and, at the domain orchestration level, to the domain correlation engine 204 and communication interface and to the SPC server's peers, receives new policies or policy updates from administration, and arbitrates conflicts or inconsistencies between policies, rules, and polices and rules. Arbitration can be effected by any suitable techniques, including source prioritization with scope filtering and least restrictive and most restrictive composition rules.

The domain policy database 244 contains both policies and correlation rules to be administered by the respective domain and the SPC server. Polices and rules are pushed to or pulled by the domain policy engine 240, domain correlation engine 232, and communication interface 236 and the SPC agents reporting to the SPC server. Orchestration tier policies differ from local protection tier policies primarily in scope. Local policies directly affect local protection components only while domain policies are scoped, via scoping indicators, to apply to potentially multiple SPC agents in one or more domains.

The domain event database 228 contains event summaries corresponding to event summaries received by the SPC server from its reporting SPC agents.

The global services 128a-q receive, from one or more SPC servers, domain event summaries and formulates, based on suitable selection factors, policy suggestions to be provided to the various SPC servers. Policy suggestions are similar to policy directives except that the SPC servers have discretion whether or not to implement the suggestion. Commonly, domain-specific policy directives would win in a tie when the suggestion is in conflict or otherwise inconsistent with a domain specific policy directive. The decision whether or not to follow the suggestion is the responsibility of the domain policy engine 240.

Although global services, for reasons of privacy, typically do not share information between or amongst themselves, this may be enabled by policy. In cross-domain, or federation, use cases, privacy considerations can limit the amount of detail shared across administrative domains but the degree of information sharing through domain event summaries would be configurable at each administrative domain. Scalability constraints are likely to appear if too much detail is shared between domains or tiers of any type. In addition, global services normally do not query SPC servers for more or different information. This structure is generally not scalable and can create security concerns for the enterprise.

The SPC console 248 is an administrator or user interface for administering the SPC architecture. By the console 248, an administrator can obtain reports, configure and update policies and rules, receive alarms, and otherwise view the security status of the communications infrastructure.

The LAN 252 is any trusted data network for transmitting messages among the SPC server and its agents and the console.

A difference between domain-level and local protection-level components is that domain-level components have children, at the local protection level, with correlation capabilities. Components, or SPC agents, at the local protection level do not and act only on local protection components contained within a local host.

In one configuration, peers in the orchestration tier 104 share policy directives. Such policy directives, and policy inferences in summaries from peers, are strictly advisory in nature, with all policy decisions and inferences being made autonomously by each peer. Policy decisions made by one peer are not binding on others. Each peer's policy determines how likely it is to directly implement a policy suggestion made by a peer. Multiple factors may be used to determine whether a given policy directive suggestion is actually implemented. Loosely applied policy might result in two peers implementing roughly identical policy, but that result would not be typical because most administrative domains are expected to implement a less-automated approach, whereby policy suggestions are reviewed by a human administrator via the SPC console 248 prior to actual implementation.

### Overall Operation of the SPC Agent

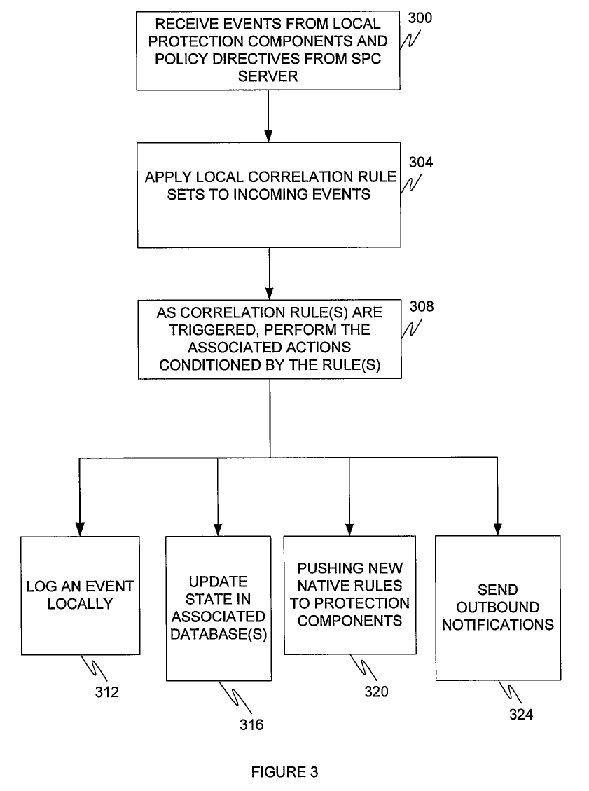

The operation of the SPC agent will be discussed with reference to FIG. 3.

In step 300, the local event collector 200 receives events from a host local protection component 120. Additionally, policy directives may be received from the communications interface 236 of the SPC server 124. The local event collector 200 filters the events and provides the filtered events to the local correlation engine 204.

In step 304, the local correlation engine 204 applies correlation rules to the incoming filtered events to identify rule violations. Generally, the correlation rules are applied in a predetermined sequence to the events.

In step 308, the local correlation engine 204 and control interface 208 perform the associated actions conditioned by the rule(s) as the local correlation rules are triggered. In one configuration, the SPC agent can heuristically generate new correlation rules based on the local policy directives and the events. The actions associated with the rule are shown in blocks 312, 316, 320, and 324. The actions are: log an event locally (box 312), update state in an associated database(s) (box 316), push a new native rule to a protection component (box 320), and/or send an outbound notification, such as an alarm or event summary, to a selected destination (box 324). Selected destinations include, in some cases, another SPC agent 116, the controlling SPC server, the console 248, or a local protection component 120.

### Overall Operation of the SPC Server

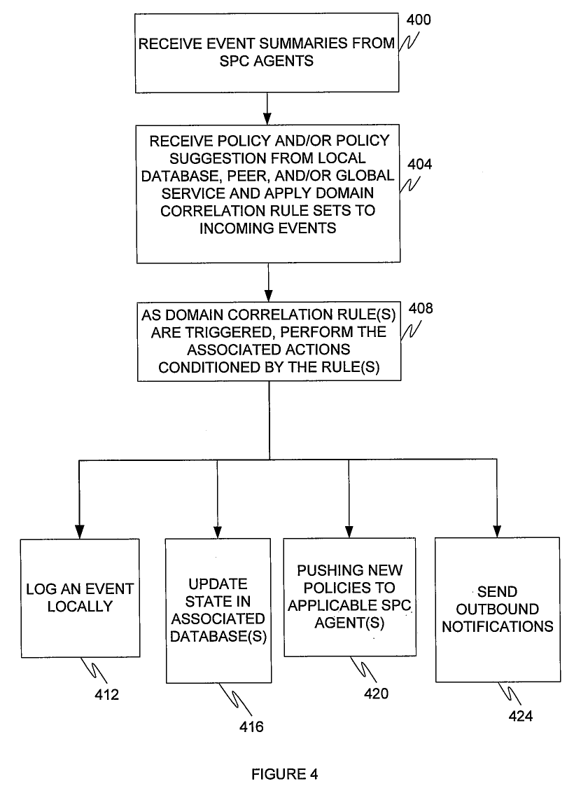

Referring to FIG. 4, the operation of the SPC server will now be discussed.

In step 400, the domain event collector 224 receives event summaries from SPC agents within its associated domain, peers at the orchestration tier 104, and global services 128.

In step 404, the domain correlation engine 232 applies domain correlation rule sets to the incoming event summaries to identify rule violations. The engine 232 does this using one or more policies received from the database 244 and/or policy directive suggestions received from a peer and global service. Generally, the domain correlation rules are applied in a predetermined sequence to the event summaries.

In step 408, the domain correlation engine 232 and communication interface 236 perform the associated actions conditioned by the policies and/or rules as the domain policies and correlation rules are triggered. In one configuration, the SPC server can generate new correlation rules based on the domain policy directives and the event summaries and new policies, typically with input from an administrator via the console 248. The actions associated with the rule are shown in blocks 412, 416, 420, and 424. The actions are: log an event locally (box 412), update state in an associated database(s) (box 416), push a new policy to a SPC agents (box 420), and/or send an outbound notification, such as an alarm or event summary, to a selected destination (box 424). Selected destinations include another orchestration tier peer, global service, console 248, and/or SPC agent 116.

### Operation of the Domain Policy Engine

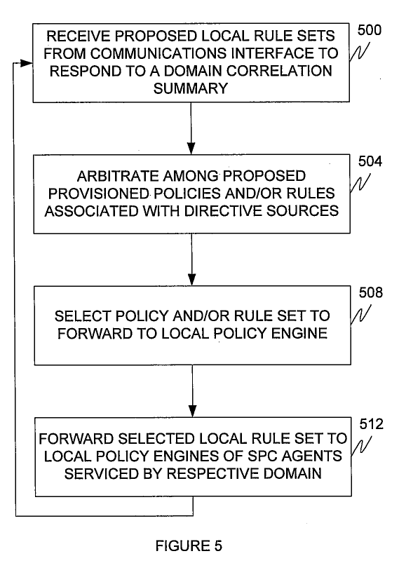

The operation of the domain policy engine 240 will be described with reference to FIG. 5.

In step 500, the engine 240 receives a proposed policy or local rule set from the communications interface 236 to respond to a domain correlation summary.

In step 504, the engine 240, in the event of a conflict, arbitrates between the currently provisioned policy directive and the proposed policy or local rule set.

In step 508, the engine 240, whether or not a conflict was found to exist and arbitrated, selects a policy or local rule set to forward to selected local policy engines 212.

In step 512, the SPC agent determines, based on scoping indicators in the policy or rule set, which SPC agents are to receive the policy or rule set and forwards the policy or rule set accordingly.

### Operation of SPC Console

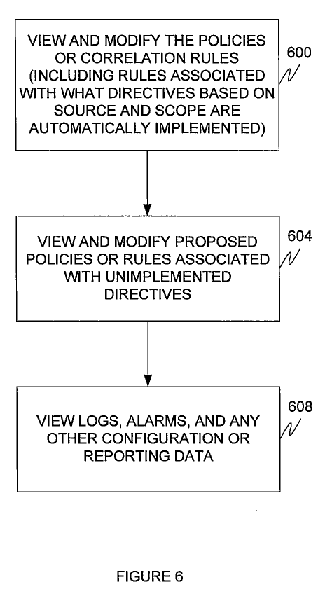

The operations of SPC console will be described with reference to FIG. 6.

In step 600, the console 248 presents, for viewing and modifying by administrators or users, selected policies and/or correlation rules (including rules associated with what directives based on source and scope are automatically implemented). The modified policies or rules are then forwarded to the domain policy engine 240 for appropriate distribution to SPC agents.

In step 604, the console presents, for viewing and modifying, selected rules associated with unimplemented directives. The modified policies or rules are then forwarded to the domain policy engine 240 for appropriate distribution to SPC agents.

In step 608, the console permits the administrator or user to view logs, alarms, and any other configuration or reporting data.

### Operational Examples

In a first example, a malicious user installs a SIP hacking tool on a PC or smartphone or the device is infected with a worm. In response, the device launches a fuzzing attack on a SIP server. The SIP server attempts to parse fuzzed SIP packets and performance is reduced or services otherwise affected. The local protection component responsible for protecting the SIP server and detects the attack. In response, the local protection component issues commands to the SIP server to block the attack. Events are sent by the local protection component to the component's corresponding SPC agent. In response, the local correlation engine 204 of the agent initiates a blocking rule in response to a policy directive in the policies and rules database 216. An event summary is forwarded to the SPC server. The event summary may contain the response, or blocking rule. In response, the domain correlation engine 232 issues a command to all SIP agents in the SPC server's domain to institute the blocking rule. Depending on the scoping tags in the policy directive, the domain correlation engine 232 may provide the summary and/or blocking rule to peers at the domain orchestration tier. An attack event notification is also sent to administration. The attack event notification includes the response action. The net result is that the Denial of Service attack is quenched and the remaining SIP servers in at least the domain of the SPC server are immunized using self-protecting communications.

In yet another example, a hacking tool targets a high value contact center located in a multi-homed site. The hacking tool overwhelms, with bogus SIP-related traffic, the capacity of a link in the contact center. The path via the link is used to reach valid agents by default, so an outage could occur. A congestion report is received by the SPC agent from a local protection component monitoring the link. In response, alternate routing is commanded by the SPC agent, based on a policy. The SPC agent and other SPC agents forward attack summaries to the SPC server. The SPC server identifies, from the attack summaries, the affected infrastructure and generates and sends alternate routing directives. An attack notification is also sent to the administrator. The administrator analyzes the attack notification for potential further action. The net result is immediate mitigation of secondary attack effects using alternate routing capabilities within self protection communications.

In yet another example, an automated telemarketing system targets the contact center. The system uses a hacking tool to perform call walking in stealth mode, collecting all of the phone numbers in the site. The system generates thousands of pre-recorded calls, flooding the contact center. The initial attack is detected by a local protection component (e.g., contact center agent or other logic) securing the SIP server. Events related to the attack are sent to the controlling SPC agent resident in the SIP server. The local correlation engine 204 of the SPC agent initiates a response, a blocking rule, based on a policy. Based on a scoping indicator in the policy or applicable correlation rule, the SPC agent forwards an event summary to its controlling SPC server. The SPC server applies preset policies or rules from the domain policy engine 240 on these and other reports within the server's domain. Depending on the scoping indicators in the pertinent policy or rule, the SPC server may (a) send all SPC agents in its domain a policy or blocking rule for the rogue endpoint, (b) the policy or blocking rule, as a suggestion, to its peers, (c) a domain summary to a global SPIT service. Other SPC servers in other domains will perform similar steps for the contact center-wide attack. As trends are discovered in the reports, the global service suggests mitigation directives to its subscribing domains. The net result is that the attacker is blocked across subscribing domains that choose to implement the suggested policy directive.

In yet another example, a malicious user installs a SIP hacking tool on a PC. The hacking tool performs call walking in stealth mode sending SIP register messages to all possible five-digit extensions. The tool collects a list of valid extensions by monitoring the SIP reply messages. The tool then determines passwords by launching a brute force attack against the extensions by sending SIP register messages to the SIP server and builds a valid login list. The malicious user sells login credentials that allow others to make long distance calls. Events in the form of failed registration instances are sent to the SPC agent. The local correlation engine, applying a policy, generates a blocking rule and a rule to limit registration rate to limit the effectiveness of the attack. The rules are forwarded to the host local protection component. An event summary is forwarded to the SPC server. The domain correlation engine 232 detects the attack heuristic and generates a blocking rule, which is sent to all SIP servers in its domain. Depending on the scoping indicators in the pertinent policy, the SPC server may send the blocking rule to its peers. An attack notification is sent to administration. The net result is that the brute-force attack is rendered ineffective through self protecting communications.

The exemplary systems and methods of this invention have been described in relation to a security architecture. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a local protection component, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

For example in one alternative embodiment, the system is disparately applied to an IDS or protection system. Examples of IDS' include integrity verifiers, log file monitors, deception systems, and network attack detection systems.

In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving, at a policy server and from a protection component, at least one event description, the protection component and policy server being operated by an enterprise;
correlating, by the policy server, the at least one event with a selected rule and/or policy;
determining, as a result of correlating, that a global service is to be notified of the at least one event, the global service being involved in mitigating a type of attack and operated by a vendor different from the enterprise; and
providing, by the policy server, the at least one event description to the global service for analysis.

2. The method of claim 1, further comprising:
receiving, from the global service, a suggested policy to mitigate a type of attack associated with the at least one event; and
determining, by the policy server, whether or not to implement the suggested policy.

3. The method of claim 1, further comprising:
providing, by the enterprise, a plurality of policy servers, each policy server controlling, independent of other policy servers, a set of agents, each agent being located in a host protection component and each set of agents representing a different domain;
when the policy server determines to implement the suggested policy, forwarding, by the policy server, the suggested policy to a respective set of agents, each member of the set of agents being required to apply the suggested policy.

4. The method of claim 1, wherein the at least one event is associated with an attack and further comprising:
providing, by the enterprise, a plurality of policy servers, each policy server controlling, independent of other policy servers, a set of agents, each agent being located in a host protection component and each set of agents representing a different domain, the policy server receiving the at least one event description corresponding to a first domain, the first domain including the protection component forwarding the at least one event description;
receiving, at a second policy server and from a second protection component in a second domain corresponding to the second policy server, at least a second event description, the at least a second event description being associated with the attack;
correlating, by the second policy server, the at least one event with a selected second rule and/or policy;
determining, as a result of correlating and by the second policy server, that the global service is to be notified of the at least a second event, the global service being involved in mitigating a type of attack and operated by a vendor different from the enterprise; and
providing, by the policy server, the at least a second event description to the global service for analysis.

5. The method of claim 1, wherein the policy server receiving the at least one event description is in a first domain and further comprising:
providing, by the enterprise, a plurality of policy servers, each policy server controlling, independent of other policy servers, a set of agents, each agent being located in a host protection component and each set of agents representing a different domain; and
forwarding, by the policy server, the suggested policy to second policy server in a second domain, the suggested policy not being mandatory to second policy server.

6. The method of claim 1, wherein the selected rule and/or policy comprises at least one scoping tag, the scoping tag describing an object to which the selected rule and/or policy applies, the object comprising one or more of: an identified administrator, an identified global service, an identified policy server, an identified agent in a protection component, and an identified class of agents in multiple protection components.

7. A computer readable medium comprising instructions that, when executed by a processor, perform the steps of claim 1.

8. A method, comprising:
providing, by the enterprise, a plurality of policy servers, each policy server controlling, independent of other policy servers, a set of agents, each agent being located in a host protection component and each set of agents representing a different domain, a first policy server controlling a first domain, the first domain including at least a first protection component, and a second policy server controlling a second domain, the second domain including at least a second protection component;
receiving, at the first policy server and from the first protection component, at least a first event description, the at least a first event description being associated with an attack;
correlating, by the first policy server, the at least a first event description with a selected first rule and/or policy to produce a first rule and/or policy;
determining, as a result of correlating and by the first policy server, that the first rule and/or policy is to be forwarded to the second policy server; and
forwarding, by the first policy server, the suggested policy to the second policy server, the suggested policy not being mandatory on second policy server.

9. The method of claim 8, further comprising:
determining, by the first policy server as a result of correlating, that a global service is to be notified of the at least a first event, the global service being involved in mitigating a type of the attack and operated by a vendor different from the enterprise; and
providing, by the first policy server, the at least one event description to the global service for analysis.

10. The method of claim 9, further comprising:
receiving, from the global service, a suggested policy to mitigate the type of attack; and
determining, by the first policy server, whether or not to implement the suggested policy.

11. The method of claim 8, wherein each protection component comprises an agent and wherein, when the first policy server determines to implement the suggested policy, forwarding, by the first policy server, the suggested policy to a respective set of agents in the first domain, each member of the set of agents being required to apply the suggested policy.

12. The method of claim 9, further comprising:
receiving, at the second policy server and from a second protection component in the second domain, at least a second event description, the at least a second event description being associated with the attack;
correlating, by the second policy server, the at least one event with a selected second rule and/or policy;
determining, as a result of correlating and by the second policy server, that the global service is to be notified of the at least a second event, the global service being involved in mitigating a type of attack and operated by a vendor different from the enterprise; and
providing, by the second policy server, the at least a second event description to the global service for analysis.

13. The method of claim 8, wherein the first rule and/or policy comprises at least one scoping tag, the scoping tag describing an object to which the first rule and/or policy applies, the object comprising one or more of: an identified administrator, an identified global service, an identified policy server, an identified agent in a protection component, and an identified class of agents in multiple protection components.

14. A computer readable medium comprising instructions that, when executed by a processor, perform the steps of claim 8.

15. An enterprise network, comprising:
(a) a plurality of security agents in communication with a respective protection device, each protection device performing a security function and the plurality of security agents and respective protection device being arranged in a plurality of domains; and
(b) a plurality of policy servers, each policy server controlling the security agents in a respective domain, wherein at least one of the following is true:
(B1) each policy server is operable to correlate a set of events against a policy and, when directed by the policy, provide a description of the set of events to a global service being involved in an attack type associated with the set of events, wherein the global service is operated by a vendor distinct from an enterprise operating the enterprise network; and
(B2) each policy server is operable to correlate a set of events against a policy and derive a rule and, when directed by the policy, provide the derived rule to a different policy server in a different domain, the rule being discretionary to the different policy server.

16. The network of claim 15, wherein (B1) is true.

17. The network of claim 16, wherein the global service is operable to provide a suggested mitigation measure in response to a common attack to multiple policy servers.

18. The network of claim 15, wherein (B2) is true.

19. The network of claim 18, wherein each policy server is operable to provide the derived rule to a respective set of agents in a respective domain, the derived rule being mandatory to the members of the respective set of agents.

20. The network of claim 15, wherein the policy comprises at least one scoping tag, the at least one scoping tag indicating an object to which the policy applies, the object being at least one of: an identified global service, an identified policy server, an identified agent, and an identified class of agents in multiple protection components.
